(19) United States
(12) Patent Application Publication
(10) Pub. No.: US 2007/0184954 A1
(43) Pub. Date: Aug. 9, 2007

(54) Method and system for loading and unloading a machine tool with tools

(76) Inventor: Josef Muser, Neu-Seiersberg (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/629,680

(22) PCT Filed: Nov. 15, 2005
(86) PCT No.: PCT/AT05/00458

§ 371 Date: Dec. 15, 2006

(30) Foreign Application Priority Data
Nov. 15, 2004 (AT) A 1902/2004

(51) Int. Cl. B23Q 3/157

(52) U.S. Cl. 483/1

(57) ABSTRACT

The invention relates to a method and system for loading tools (3, 3′) in and unloading them from a machine tool (5), whereby the tools (3, 3′) are removed from a magazine (1), transferred to an intermediate storage (11) and supplied from said intermediate storage (11) to the machine tool (5). The inventive method is characterized in that the tools (3, 3′), during transfer to the machine tool (5), are simultaneously removed from the intermediate storage (11) and the machine tool (5) or inserted into the same. The invention also relates to a device for carrying out the method.

The invention relates to a method for loading and unloading a machine tool with tools, in which tools are taken from a hopper at first to an intermediate storage unit and are supplied from the intermediate storage unit to the machine tool.

In connection with an especially automated loading and/or unloading of a machine tool, e.g. a milling machine, it is known, with the help of especially automated apparatuses which can be moved along several axes, to take up a prepared tool by an apparatus provided with a gripper device, whereupon the supplied tool is deposited or arranged in the machine tool after a movement of the apparatus between a hopper or storage unit to a transfer position on or in the machine tool and is usually installed in the machine tool from the receiving or transfer station by way of a respective changer apparatus. At the same time with the receiving of a new tool by the changer apparatus of the machine tool, a tool used in a directly preceding processing step is placed in the receiving or transfer station or position and is received by the apparatus which can be moved especially along several axes and returned to a storage unit or a hopper. Such methods and systems or apparatuses for loading and unloading a machine tool with tools are known for example from DE 33 20 762 A, DE 39 42 600 A, DE 41 16 091 C, DE 195 10 498 A or DE 299 02 127 U. The disadvantageous aspect in such known embodiments is especially the fact that when using conventionally large hoppers or storage units, the time for the movement of the apparatus between the storage unit or hopper and the transfer position or the machine tool directly can cover a time period of 30 to 120 seconds for example, so that especially in the case of shorter utilization or process intervention periods a new tool must be received after the delivery of a directly previously used tool and needs to be transported again to the area of the machine tool or its transfer position.

A tool changing system for program-controlled milling and drilling machines is known from DE 101 63 294 A, in which an intermediate storage unit is provided which is configured as a star-like transfer element. Said intermediate storage unit is used simultaneously both as a means for providing the next required tools as well as a transfer element for manipulating the tools themselves. The constructive configuration of such an intermediate storage unit is complex as a result of the complex functionality and problems arise in operation in certain situations because the removal of tools from the hopper and from the machine tool often cannot be performed simultaneously when the current assignment of the intermediate storage unit does not allow so.

A further solution with intermediate storage units is disclosed in DE 198 51 264 A. The tool throughput is limited in this solution and the linear movement of the intermediate storage unit is relatively complex.

It is the object of the present invention to avoid such disadvantages and to further develop the above method in such a way that the complexity of the apparatuses involved can be kept as low as possible. A further object of the invention is to use proven processes and components to the highest possible extent in order to keep development work as low as possible. In any case, minimal transfer times are to be realized. Finally, it is an object of the invention to provide an apparatus for performing the method which fulfils the above requirements.

It is provided for in accordance with the invention that in the transfer to the machine tool the tools are taken via a changer apparatus simultaneously from the intermediate storage unit and the machine tool or are inserted into the same. The relevant aspect in the invention is on the one hand the separation of the functionality of the intermediate storage unit from the actual tool transfer to the machine tool by simultaneously using the proven system of the simultaneous exchange of the tools by a so-called ATC (Automatic Tool Changer). The above requirements are fulfilled in an optimal manner by such a method.

An embodiment of the method in accordance with the invention which is especially simple and reliable from a constructional viewpoint is provided when the changer apparatus performs a rotational movement during the transfer.

An especially advantageous and efficient procedure of the method in accordance with the invention can be achieved in such a way that a transfer of tools from the hopper to the intermediate storage unit and vice versa occurs before or after the transfer of the tools from the changer apparatus to the machine tool. It is especially advantageous in this respect when the intermediate storage unit performs a rotational movement during the transfer of tools to the hopper.

Because a low number of tools are prepared and stored in accordance with the invention in an intermediate storage unit close to the machine tool or its transfer station it is ensured that even in the case of short engagement and utilization periods of a tool an exchange of a newly inserted tool against a tool used in a preceding working step in a known changer apparatus is influenced or determined by the very rapid and short time of use of the changer apparatus on the machine tool and is independent of the manipulation time which works between the machine and the transfer position of the apparatus and the associated storage unit or hopper. Standstill periods are prevented which are caused by the manipulation time of the apparatus provided between the machine tool and the storage unit, so that when a respective plurality of tools are provided or prepared in the intermediate storage unit close to the machine tool or transfer position, it is possible to work with very short times of use of the tools in a machine tool. Moreover, the guidance of the method in accordance with the invention also offers advantages with respect to a rapid and direct change of a tool in a machine tool, even when using a tool with longer times of use or cycle times.

Such a rapid change between tools to be used in a machine tool is further promoted in such a way that after use a tool can be brought to the intermediate storage unit from the machine tool or its transfer station as corresponds to a further preferred embodiment of the method in accordance with the invention. It is thus not only proposed in accordance with the invention to prepare and store tools to be used in the intermediate storage unit close to the machine tool or its transfer position, there is also a rapid and simplified transfer of a tool used in a preceding work step by using short paths and thus short movement times of the changer apparatus in the downstream machine tool, so that the changing process can be accelerated even further.

For further simplification and acceleration of receiving and transferring tools to a machine tool it is proposed in accordance with a further preferred embodiment that the tools are stored in the intermediate storage unit according to their sequence of use in the machine tool. Because the tools are stored in accordance with the invention in the intermediate storage unit according to their time sequence for use it is ensured that a simply structured intermediate storage unit is sufficient which can be moved or actuated step by step, so that after the removal of a tool stored in the intermediate storage unit and appropriately simultaneous transfer of an immediately previously used tool to the intermediate storage unit by a simple movement of the intermediate storage unit, e.g. in a step by step manner, according to the number of the receiving positions in the intermediate storage unit a tool used for the next work step can be brought to the area of the changer apparatus of the downstream machine tool without requiring any complex control for the drive of the intermediate storage unit.

For an especially simple and reliable handling of the tools it is proposed according to a further preferable embodiment that the tools are received and stored via adapters in the intermediate storage unit. The use of such adapters protects the tools and their receiving elements. Especially by taking into account that substantially standardized receiving elements of the individual tools are provided for use in the machine tool, it is possible to make do with standardized adapters, so that all manipulation devices and apparatuses between the hopper and the intermediate storage unit and between the intermediate storage unit and the application in the machine tool can be adjusted accordingly to the use of a uniform configuration of an adapter.

Special measures for accelerating the movement of the apparatus working between the hopper and the storage unit as well as the intermediate storage unit can be omitted on the basis of the fact that by providing the use of an intermediate storage unit short changing periods are enabled in the area of the changer apparatus of the machine tool. Moreover, the time which is available when providing a respective number of receiving positions in the intermediate storage unit can also be used for directly checking an employed tool after removing from the machine tool because it can be assumed that a sufficient number of successively useable tools have already been prepared in the intermediate storage unit even in the case of short cycle and application times. In this connection it is proposed according to a further preferred embodiment of the method in accordance with the invention that after use the tools are subjected to an inspection and/or measurement especially by use of one of the axes of the transport apparatus prior to return to the hopper. Directly after removal of a previously employed tool from the intermediate storage, it can be subjected to an inspection or measurement by the transfer apparatus operating between the hopper or storage unit and the intermediate storage unit, especially by using one of the axes of the transport apparatuses, so that additional work steps with respect to a subsequent removal of a tool from the hopper or storage unit and delivery to a respective inspection and/or measurement as well as additional adjusting steps can be avoided. Such additional handling of a tool will become necessary in cases where according to the known state of the art a transport is carried out directly between the hopper or storage unit and the transfer station or the machine tool. Respectively long standstill periods would occur especially in the case of short cycle times or times of use of a tool in the machine tool, as was already mentioned above.

The present invention further relates to a system for loading and unloading a machine tool with tools, comprising a hopper for storing the tools, an intermediate storage unit for providing tools on a short-term basis. This system is characterized in accordance with the invention in such a way that a changer apparatus is provided in addition which is configured to simultaneously remove tools from the intermediate storage unit and the machine tool or to insert the tools into the same.

As already mentioned above, the provision of an intermediate storage unit enables the preparation and storage of a respective number of tools to soon be used, so that in the case of respectively rapidly working changer apparatuses in the area of the machine tool there will not be any standstill periods of the machine tool even in the case of short cycle times or times of use of tools.

According to a further preferred embodiment, it is proposed for the purpose of further accelerating the changing process that a tool can be received in the intermediate storage unit after use in the machine tool.

For forming an intermediate storage unit that is especially easy to use it is further proposed that the tools can be received in the intermediate storage unit in their time sequence of use in the machine tool, as corresponds to a further preferred embodiment of the system in accordance with the invention.

For the purpose of easy receiving and handling of the intermediate storage unit, it is proposed for the same in accordance with a further preferred embodiment that the intermediate storage unit is formed by a disk-like, plate-like or chain-like element which comprises a plurality of receiving devices or openings for receiving tools. Such a disk-like, plate-like or chain-like intermediate storage unit can be provided in a respectively compact and space-saving manner in the region of the transfer position or station, or directly on the machine tool. It is thus also easy to handle. Moreover, such a disk-like, plate-like or chain-like intermediate storage element enables the simple provision of respective receiving elements for receiving the tools and a simple removal of the same by the changer apparatus of the machine tool.

According to an especially preferred embodiment it is proposed that adapters for receiving the tools from the hopper and for storage or receiving are provided in the intermediate storage unit, with such adapters allowing not only a simplified handling of the tools but also a respective protection of the same.

For providing a large number of tools to be used in a machine tool for a large variety of work processes, it is proposed according to a further preferred embodiment of the invention that the hopper or the storage unit is formed by a known matrix hopper. Such a matrix hopper allows providing a plurality of tools in a compact and cost-effective way, which tools can be handled by automated apparatuses or robots.

As already mentioned above, the provision of an intermediate storage unit which allows generally short changing periods in the machine tool and prevents standstill periods by taking into account the movement of the manipulation apparatus between the magazine or storage unit and the machine tool also allows directly checking or measuring a used tool. In this connection it is proposed in accordance with a further preferred embodiment of the system in accordance with the invention that an apparatus for checking and/or measuring a tool after use is provided in addition. Such devices for checking and/or measuring can be arranged in the region of the hopper or the storage unit and can be reached directly by the transfer apparatus used between the hopper or storage unit and the machine tool.

For the purpose of an automation of an exchange or change of tools it is proposed in accordance with a further preferred embodiment that additionally a supply or removal apparatus is provided for used or damaged tool and for new tools.

As already mentioned above, substantially automated apparatuses are used for a manipulation of the tools. It is proposed in accordance with a further preferred embodiment of the invention that the apparatus for transporting tools is formed in the known manner by an automatically controlled robot.

The present invention is explained in closer detail below by reference to the embodiments shown in the drawings, wherein:

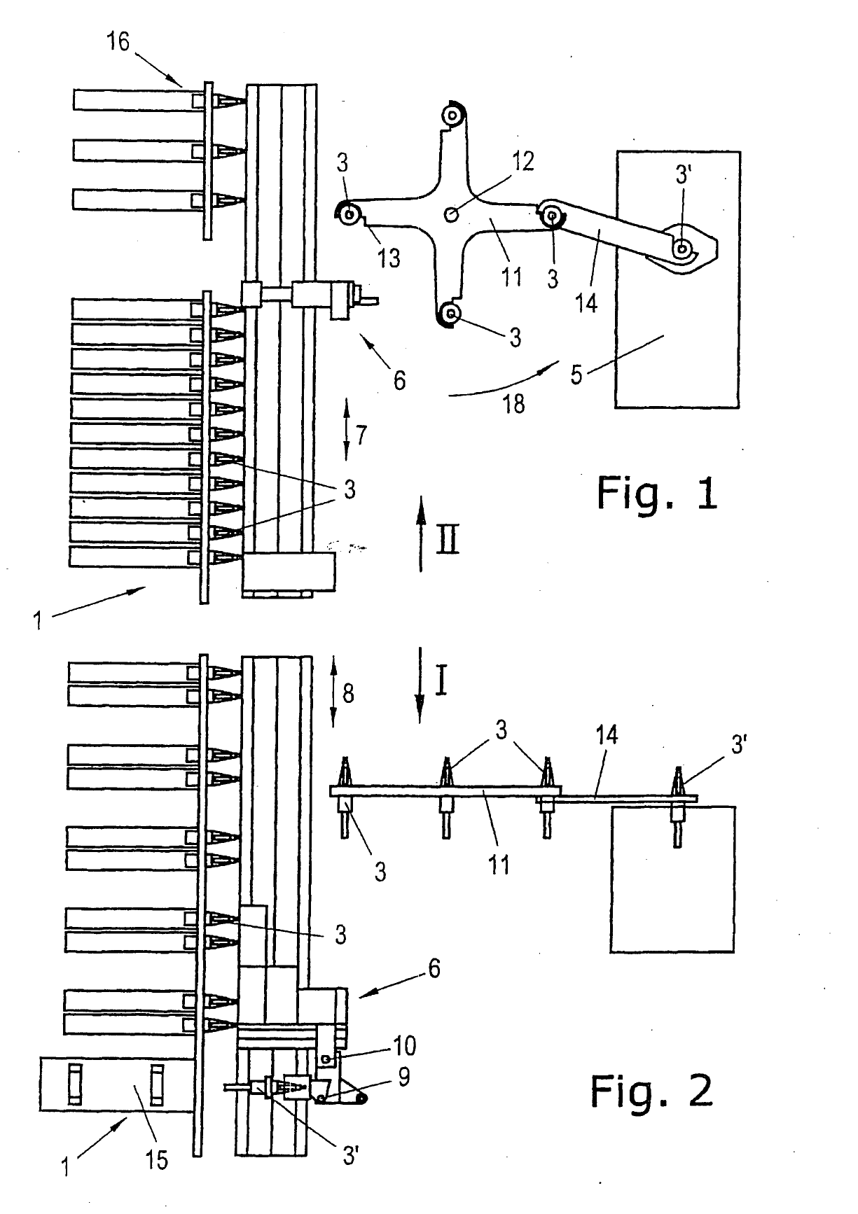

FIG. 1 shows a schematic top view of a system in accordance with the invention;

FIG. 2 shows a side view of the system of FIG. 1;

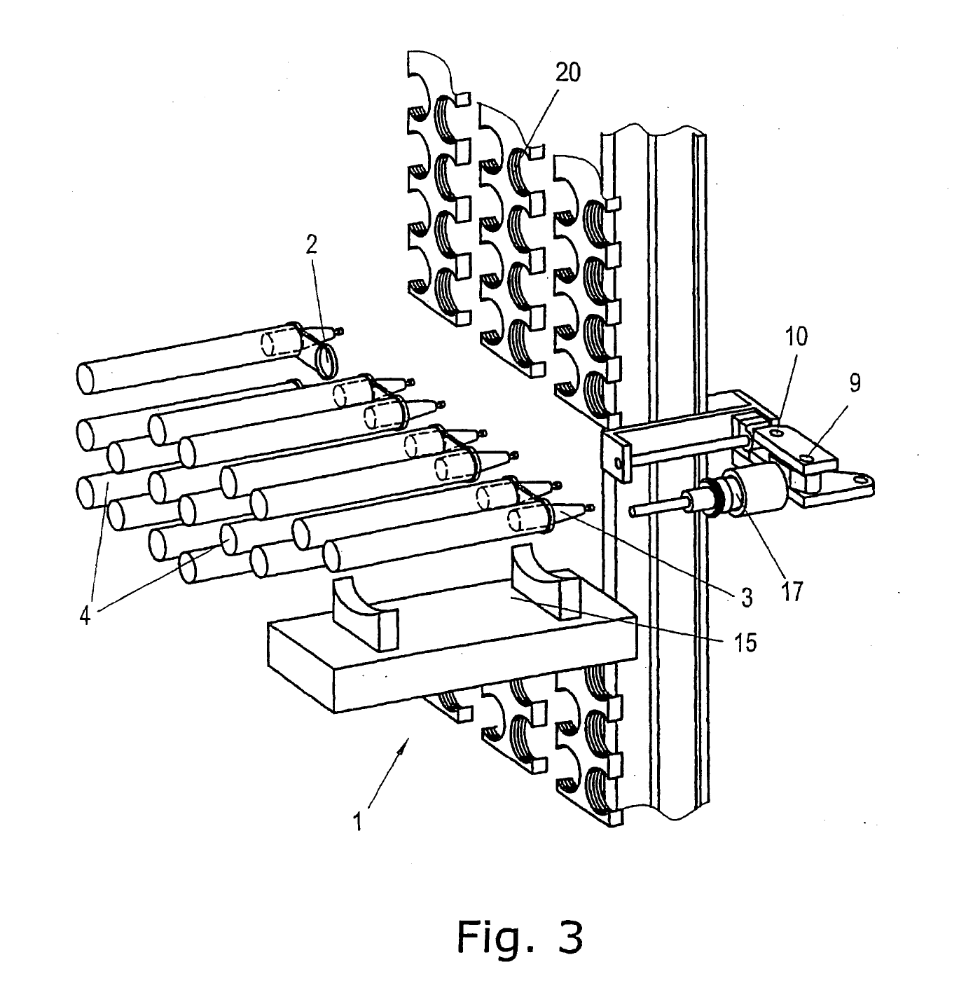

FIG. 3 shows a schematic axonometric view of a detail of the system of FIG. 1 and FIG. 2, and

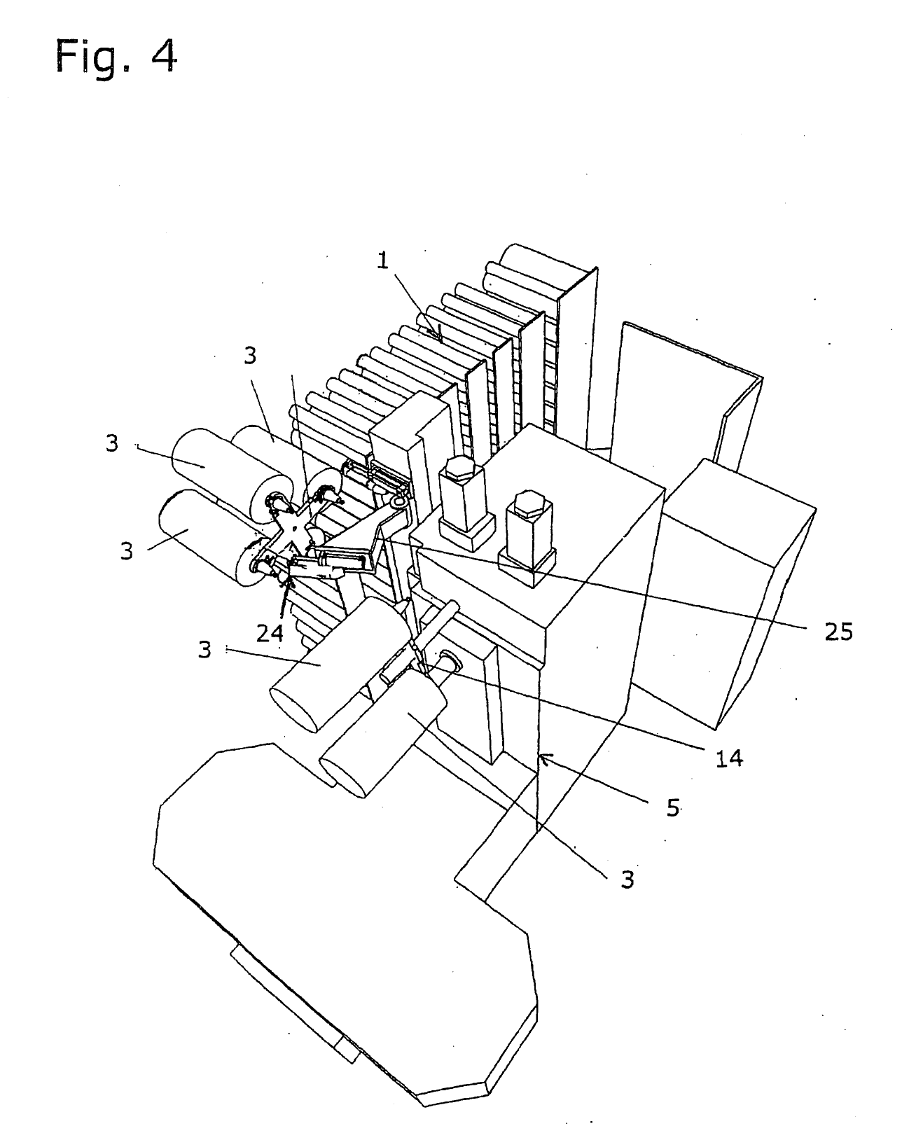

FIG. 4 an axonometric representation of an alternative embodiment of a system in accordance with the invention.

Reference numeral 1 generally designates a storage unit or hopper in the drawings, with a plurality of tools 3 being held in respective storage elements 4 in a plurality of receiving openings which are shown especially in FIG. 3 and are each designated with reference numeral 2. Such a storage unit or such a hopper 1 can be formed especially by a matrix hopper in which a plurality of tools 3, e.g. drill bits indicated for example schematically in FIGS. 2 and 3, in an x/y system of coordinates.

For the purpose of removing tools 3 from the hopper or storage unit 1 and for transferring the same to a machine tool designated schematically in FIG. 1 with reference numeral 5, an apparatus is provided which is generally designated with reference numeral 6 and which is movable and/or swivelable along several axes and/or directions, with one movement in the horizontal direction being indicated in FIG. 1 with the double arrow 7, one movement in the vertical direction by a double arrow 8 in FIG. 2 and the apparatus 6 having at least two pivoting axes 9 and 10, as is indicated in FIG. 2 and FIG. 3. A tool 3 can be removed in such a way from a hopper 1 by such an apparatus or manipulator 6 and can be handled accordingly.

In the system as shown in FIG. 1 and FIG. 2, an intermediate storage unit 11 is provided between the hopper 1 and the machine tool 5, which intermediate storage unit is formed in the illustrated embodiment by a disk-like or plate-like element which is rotatable about an axis schematically designated with reference numeral 12. The intermediate storage unit 11 comprises a plurality of especially equidistant spaced receiving positions and openings 13 in which a tool 3 each can be received. A tool 3 is removed from the intermediate storage unit 11 by means of a changer apparatus which is schematically indicated with reference numeral 14 and is inserted into the machine tool 5 in order to machine a workpiece (not shown in closer detail). The changer shown in FIG. 1 and FIG. 2 is a so-called double changer apparatus 14 with which a tool 3 can be removed from the intermediate storage unit 11 and simultaneously a directly previously used tool is removed from the machine tool, which tool is designated in FIG. 1 and FIG. 2 with reference numeral 3′.

A prepared or stored tool 3 can thus be removed from the intermediate storage unit 11 in an exceptionally short and rapid changing process and be transferred directly to the machine tool 5, with the rapid changing process via the changer apparatus 14 being independent from the duration of a movement of the apparatus 6 between a hopper 1 which optionally may have very large dimensions and the intermediate storage unit 11.

After a change of a newly used tool 3 against a tool 3′ used in a preceding work step, a removal of an already used tool from the intermediate storage unit 11 occurs by the apparatus 6 and there is a direct return to the hopper or the storage unit 1.

By considering the fact that even in the case of short cycle or application periods of a tool 3 in the machine tool 5 the time required for a change of a tool 3 is independent of the duration of the movement of the apparatus 6 by providing a prepared number of tools 3 arranged in time sequence of use in the machine tool 5 because it is not necessary to carry out a direct transfer between the apparatus 6 and the changer apparatus 14 for the use of a new tool. As a result, an already employed tool 3′ can be subjected to an inspection and/or measurement after a removal from the intermediate storage unit 11, as is indicated in FIG. 2 and FIG. 3 by a respective apparatus 15. In the apparatus 15, the alignment and/or further usefulness of an already used tool 3′ can be checked by using a laser measuring device (not shown in closer detail) especially by use of one of the axes of the transport apparatus.

Once the checking of an already used tool 3′ has been successfully completed, tool 3′ will be returned to the respective storage place in the optionally large-volume matrix hopper 1.

FIG. 1 further schematically indicates a supply and removal apparatus or station with reference numeral 16, in which consumed tools can be deposited for example and can optionally be replaced manually by new tools. Such tools can be transferred subsequently from the supply and removal apparatus 16 to the actual matrix hopper 1.

The figures indicate further that the individual tools 3 are received by respective adapters 17, which ensures careful receiving and transferring of the individual tools 3. By considering the fact that respective receiving elements of the tools 3 which are usually formed by a standardized cone are standardized, it is possible to make do with a standardized embodiment of an adapter 17 and the receiving elements of the individual transport apparatuses 6 and 14 and the receiving openings 13 of the intermediate storage unit 11 can be adjusted accordingly to the shape of the adapters 17.

Instead of the disk-like or plate-like intermediate storage unit 11 as shown in FIG. 1 and FIG. 2 with the receiving positions or openings 13 as shown in FIG. 1 and FIG. 2 which are arranged at the ends of arms of the disk-like or plate-like intermediate storage unit 11, it is also possible to use a substantially circular intermediate storage unit 11 which comprises a respective number of receiving openings or positions 13 on its outside circumference. As an alternative it is possible to use a chain element which comprises respective receiving elements on its circumference.

A drive for the intermediate storage unit 11 and the axis 12 has been omitted in the figures for the sake of simplicity of the illustration. Especially in the case that the tools 3 are received in the intermediate storage unit 11 according to the temporal sequence of the tools, a positioning of a subsequent tool 2 into the region of the access position of the changer apparatus 14 can occur by a step by step movement according to the distance of adjacent receiving openings 13 within the terms of arrow 18 in FIG. 1 for example by simple swiveling or rotating of the intermediate storage unit 11 after receiving a tool 3′ used in a preceding work step.

It is especially further indicated in FIG. 3 that the storage unit or the hopper 1 is formed for example from the layered structure of sheet metal, as is schematically indicated in FIG. 3 with reference numeral 20. Such sheet metal can be treated in a simple and cost-effective manner by jet cutting or with laser and can be compiled subsequently into a respective storage configuration 1. As a result, an adjustment or expansion to required receiving capacities can thus be made.

Moreover, it is shown especially in FIG. 1 and FIG. 2 that in addition to the possibility of a preparation and storage of a low number of tools 3 to be used especially in temporal sequence in the intermediate storage unit 11, the intermediate storage unit 11 also ensures respectively short transport paths both to the hopper or storage unit 1 as well as the intermediate storage unit 11 and the changer apparatus 14 of the machine tool 5, so that in this way changing periods and standstill periods of the machine tool 5 as are required by an exchange of a tool 3 can be reduced or minimized accordingly.

Departing from the hopper or storage unit which is shown in the figures and which is especially arranged as a matrix hopper 1, it is understood that other embodiments of a hopper can be used such as a tower hopper with a rotatable tower storage unit or a similar hopper 1, from which tools can be removed with an apparatus 6 and can be supplied to an intermediate storage unit 11 which is arranged close to the machine tool 5 or a transfer station or position of the same.

In the embodiment of FIG. 4, the hopper 1 is pivoted relative to machine tool 5 for reasons of space, so that the tools 3, 3′ need to be pivoted about an axis on their path between hopper 1 and the machine tool 5, which axis is perpendicular to its longitudinal axis. A pivoting device 24 comprises a pivoting lever 25 in order to remove the tools 3, 3′ from the intermediate storage unit 11, to pivot the same and to supply them to the changer apparatus 14.

1.-19. (canceled)

20. A method for loading and unloading a machine tool with tools, in which the tools are taken from a hopper at first to an intermediate storage unit and are supplied from the intermediate storage unit to the machine tool, wherein in a transfer to the machine tool the tools are taken via a changer apparatus simultaneously from the intermediate storage unit and the machine tool or are inserted into the same.

21. A method according to claim 20, wherein the changer apparatus performs a rotational movement during the transfer.

22. A method according to claim 20, wherein a transfer of tools from the hopper to the intermediate storage unit and vice-versa occurs before or after the transfer of the tools from the changer apparatus to the machine tool.

23. A method according to claim 20, wherein the intermediate storage unit performs a rotational movement during the transfer of tools to the hopper.

24. A method according to claim 20, wherein the tools are stored in the intermediate storage unit according to their sequence of use in the machine tool.

25. A method according to claim 20, wherein the tools are received and stored in the intermediate storage unit via adapters.

26. A method according to claim 20, wherein the tools are subjected to a check and/or measurement prior to a return to the hopper.

27. A method according to claim 20, wherein the tools are swiveled about an axis differing from their longitudinal axis in their transfer from the hopper to the intermediate storage unit or in their transfer from the intermediate storage unit to the machine tool.

28. A system for loading and unloading a machine tool, comprising tools, a hopper for storing the tools, an intermediate storage unit for quickly providing tools, wherein a changer apparatus is additionally provided, which is configured to simultaneously remove tools from the intermediate storage unit and the machine tool or to insert them in the same.

29. A system according to claim 28, wherein the changer apparatus is arranged as a two-arm lever which can be pivoted about a central axis and is provided at its ends with tool holders.

30. A system according to claim 28, wherein the intermediate storage unit is provided with a rotatable configuration.

31. A system according to claim 30, wherein the intermediate storage unit is arranged as a multi-arm lever whose arms project from a hub in a star-like manner in equal distances.

32. A system according to claim 28, wherein adapters are provided for receiving the tools from the hopper and for storing or receiving in the intermediate storage unit.

33. A system according to claim 28, wherein the hopper is arranged as a matrix hopper.

34. A system according to claim 28, wherein in addition an apparatus is provided for checking and/or measuring tools after use.

35. A system according to claim 28, wherein in addition a supply and removal apparatus is provided for used or damaged tools and new tools.

36. A system according to claim 28, wherein the apparatus for transporting the tools is arranged as an automatically controlled robot.

37. A system according to claim 28, wherein an apparatus is provided for pivoting the tools.

38. A system according to claim 28, wherein the hopper is formed by a layered structure of sheet metal.
